(19) United States
(12) Patent Application Publication
(10) Pub. No.: US 2015/0221015 A1
(43) Pub. Date: Aug. 6, 2015

(54) SYSTEMS AND METHODS FOR ADJUSTING A SHOPPING PLANNER BASED ON IDENTIFICATION OF SHOPPING PREDICTORS

(71) Applicant: Toshiba Global Commerce Solutions Holdings Corporation, Tokyo (JP)

(72) Inventor: Sudipta Kumar Laha, West Bengal (IN)

(73) Assignee: Toshiba Global Commerce Solutions Holdings Corporation, Tokyo (JP)

(21) Appl. No.: 14/182,363

(22) Filed: Feb. 18, 2014

Related U.S. Application Data
(60) Provisional application No. 61/934,874, filed on Feb. 3, 2014.

(51) Int. Cl. G06Q 30/06; G10L 15/26

(52) U.S. Cl. CPC G06Q 30/0631; G06Q 30/0633; G06Q 30/0641; G10L 15/265

(57) ABSTRACT

Systems and methods for adjusting a shopping planner based on identification of shopping predictors are disclosed. According to an aspect, a method includes receiving user interface content. The method also includes determining one or more shopping predictors based on the user interface content. Further, the method includes adjusting a shopping planner based on the identified shopping predictor(s).

### CROSS REFERENCE TO RELATED APPLICATION

This application claims the benefit of U.S. Provisional Patent Application No. 61/934,874, filed Feb. 4, 2014 and titled SYSTEMS AND METHODS FOR ADJUSTING A SHOPPING PLANNER BASED ON IDENTIFICATION OF SHOPPING PREDICTORS, the content of which is hereby incorporated herein by reference in its entirety.

### TECHNICAL FIELD

The present invention relates to shopping assistance, and more specifically, to adjustment of a shopping planner based on identification of shopping predictors.

### BACKGROUND

Consumers often prepare shopping lists to assist with shopping within a retail environment, such as a “brick and mortar” store. By doing so, shopping can become more efficient for the consumer, and the consumer is less likely to forget to purchase a needed item. However, a consumer can forget to add one or more items to the shopping list and may only realize after shopping that these items have been missed. In such instances, there can be a loss of efficiency, because the consumer will need to later return to the store to purchase the missed items. For at least this reason, it is desired to provide systems and techniques for assisting consumers with generating a shopping list, or more generally with planning their shopping.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for adjusting a shopping planner based on identification of shopping predictors. According to an aspect, a method includes receiving user interface content. The method also includes determining one or more shopping predictors based on the user interface content. Further, the method includes adjusting a shopping planner based on the identified shopping predictor(s).

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of a system for adjusting a shopping planner based on identification of one or more shopping predictors in accordance with embodiments of the present invention;

FIG. 2 is a flowchart of an example method for implementing one or more features at a computing device in accordance with embodiments of the present invention; and

FIG. 3 is a flow diagram of a system for adjusting a shopping planner based on identification of shopping predictors in accordance with embodiments of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

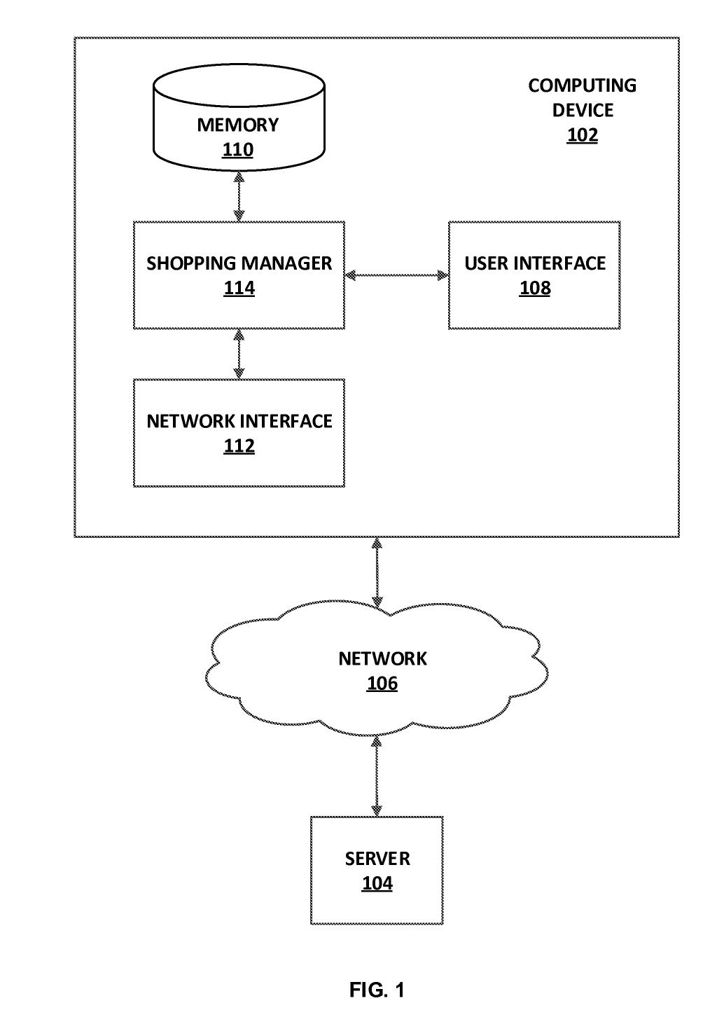

The presently disclosed invention is now described in more detail. For example, FIG. 1 illustrates a block diagram of a system 100 for adjusting a shopping planner based on identification of one or more shopping predictors in accordance with embodiments of the present invention. The system 100 may be implemented in whole or in part in a computing device 102. For example, the computing device 102 may be any suitable computing device such as a mobile computing device. Example mobile computing devices include a smartphones and tablet computers. The computing device 102 may be communicatively connected to a server 104 or another computing device via a communications network 106, which may be, for example, the Internet, a mobile communications network, and/or any suitable local area network (LAN), either wireless and/or wired.

The components of the computing device 102 may each include hardware, software, firmware, or combinations thereof. For example, software residing in memory of a respective component may include instructions implemented by a processor for carrying out functions disclosed herein. As an example, the computing device 102 may each include a user interface 108 including a display (e.g., a touchscreen display), one or more buttons, one or more speakers, a microphone, an image capture device (e.g., a still or video camera), the like, and/or other equipment for interfacing with a user. The computing device 102 may also include memory 110. The computing device 102 may also include a suitable network interface 112 for communicating with the network 106.

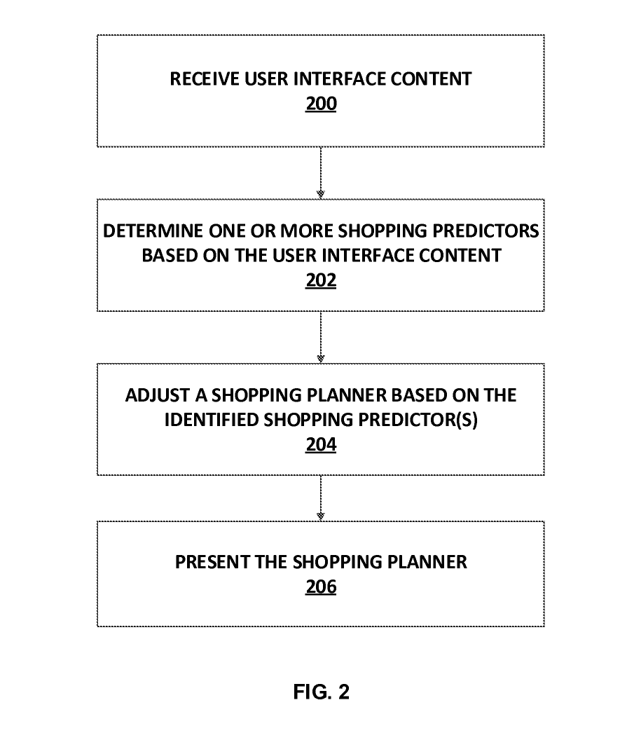

In accordance with embodiments of the present invention, features of a computing device may be implemented based on receipt of user interface content at the computing device. FIG. 2 illustrates a flowchart of an example method for implementing one or more features at a computing device in accordance with embodiments of the present invention. The method of FIG. 2 is described as being implemented by a shopping manager 114 of the computing device 102, although the method may be implemented by any suitable computing device or multiple computing devices. The method may be implemented by hardware, software, and/or firmware of the computing device 102 and/or another computing device. For example, the memory 110 and a processor (not shown) of the computing device 102 may implement the method.

Referring to FIG. 2, the method includes receiving 200 user interface content. For example, the shopping manager 114 may receive user interface content such as, for example, audio content, video content, multimedia content, text-based content, the like, and combinations thereof. The user interface 108 or another component (e.g., the network interface 112) may receive the content and suitably communicate a portion or all of the content to the shopping manager 114. The memory 110 may store the user interface content.

In an example of receiving audio content, the user interface 108 may include a microphone capable of converting received sound into an electrical signal. The user interface 108 may convert the electrical signal to audio data and communicate the audio data to the shopping manager 114. The microphone may receive, for example, sounds of a conversation among the user and another person or sounds of a commercial on a television. Alternatively, in another example, the network interface 112 may receive audio content. For example, the network interface 112 may receive web content including audio content from the server 104.

In an example of receiving video content, the computing device 102 may include a multimedia player capable of playing back multimedia content, such as video content or audio content. The multimedia player may be implemented by software, hardware, firmware, or combinations thereof. Further, the multimedia player may be part of the user interface 108. The user interface 108 may communicate all or a portion of the multimedia content to the shopping manager 114. Alternatively, in another example, the network interface 112 may receive multimedia content. For example, the network interface 112 may receive web content including multimedia content from the server 104.

The method of FIG. 2 may include determining 202 one or more shopping predictors based on the user interface content. For example, the shopping manager 114 may identify one or more shopping-related words based on received audio content, video content, multimedia content, text-based content, and/or the like. The shopping manager 114 may be configured to transcribe, translate, interpret, or otherwise interpret some or all of the words within received user interface content. For example, the shopping manager 114 may include a speech recognition function configured to translate or transcribe spoken words in multimedia content into text. Further, the shopping manager 114 may determine that some or a portion of words within the text relate to shopping. As an example, the shopping manager 114 may maintain a list of words and/or phrases considered to be related to shopping, and identify any words and/or phrases that match words or phrases within the list. The matching works and phrases may be identified as shopping-related words. In this way, the shopping manager 114 may determine shopping-related words or phrases based on the user interface content.

The shopping manager 114 may use words or phrases identified as being shopping-related words or phrases for determining one or more shopping predictors. For example, the shopping manager 114 may receive user interface content, such as audio content, and subsequently identify the word “recipe” from the user interface content. In this example, the shopping manager 114 may identify other words associated with the recipe. These may be words following the word “recipe” that correspond to ingredients. The shopping manager 114 may identify the ingredients (or words) as being candidates for a shopping list.

In an example, a shopping manager can predict the items in a shopping cart by mapping multiple contents from multiple shopping cart predictors. The shopping manager can detect phrases (e.g., “want to buy,” “wonderful product,” and “like to have”) and multimedia content (e.g., picture of the product) from the wearable device to predict one or more items in the shopping cart.

The method of FIG. 2 includes adjusting 204 a shopping planner based on the one or more identified shopping predictors. Continuing the aforementioned example, the shopping manager 114 may add the candidate ingredients (or words) to a shopping list. The shopping list may be a list residing on the computing device 102 or on a remote server, such as the server 104. The shopping list may have been created by the user and may include a list of items previously entered by the user. In another example, the shopping manager 114 may edit a shopping list based on the candidate words, such as replacing one item on the list by a similar candidate word.

The method of FIG. 2 includes presenting 206 the shopping planner. For example, the shopping manager 114 may control the user interface to present the shopping list to a user. For example, the shopping manager 114 may control a display of the computing device 102 to display the shopping list. In another example, the shopping list may be provided to another computing device, such as the server 104.

In accordance with embodiments of the present invention, multiple categories may be defined within a shopping planner. For example, the shopping list may include the following categories: grocery store, hardware store, and electronics store. The grocery store category may include the following items: cereal and bread. The hardware store category may include the following items: nails and hammer. The electronics store category may identify a cable. A shopping list identifying the categories and their respective items may be stored in the memory 110. The shopping manager 114 may determine one or more items to add to a shopping list. For example, the shopping manager 114 may determine that eggs and sugar are to be added to a shopping list in accordance with embodiments of the present invention. Further, the shopping manager 114 may determine that eggs and sugar are grocery items and add these items to the grocery store category in the shopping list. In this way, the shopping-related words can be associated with one of the categories.

In accordance with embodiments of the present invention, the shopping manager 114 may determine one or more items in a shopping cart and generate a shopping suggestion based on the item(s). For example, the shopping manager 114 may identify one or more items in a shopping cart for in-store or online shopping. Subsequently, the shopping manager 114 may determine alternatives to the items in the shopping cart and present the suggested items to the user via the user interface 108. The alternative items may be other items available for purchase in the store or in the online shopping website associated with the shopping cart. For example, the shopping cart may include canned food of a particular brand, and the shopping manager 114 may suggest other brands of canned food that are also available in the store or by the online shopping website. In another example, the shopping manager 114 may suggest alternative stores or online shopping websites where an item identified in the shopping list or an alternative item can be purchased.

In accordance with embodiments of the present invention, user interface content received at a computing device, such as the computing device 102 shown in FIG. 1, can include conversations among people or background noise. These sounds can include recipes or other descriptions of or clues about items that may be used for adjusting a shopping list residing on the computing device. These sounds can be used to predict or correct the shopping list by analysis of the sounds and categorization of items in a shopping list or shopping cart. A shopping manager, such as the shopping manager 114, may adjust a shopping list or suggest shopping locations based on this data made available from various activities of a user, such as a conversation with another person or a television program being watched by the user.

In an example scenario, a person may be watching a television program or advertisement which provides information about a recipe or describes a food. A user interface of a computing device being carried by the person may be set to a mode for collecting information for adjusting a shopping planner. For example, the shopping manager 114 may be activated to operate or function in accordance with embodiments of the present invention. The user interface 108 may receive sounds of the television program or advertisement, and the shopping manager 114 may determine shopping predictors based on the sounds. For example, the shopping manager 114 may identify words of a recipe described in television program or advertisement. The shopping manager 114 may determine a list of words as being associated with a recipe by determining, for example, that the words are ingredient items and described along with measurements for a recipe (e.g., a cup, a tablespoon, and the like). The shopping manager 114 may predict that the person may be interested in buying such items for the recipe, and therefore add them to a shopping list on the computing device 102. Further, the items may be categorized based on their location in a grocery store (e.g., aisles in the store where the items can be expected to be stocked).

In another example, the shopping manager 114 may categorize different items based on predetermined criterion. When a user is shopping, the shopping manager 114 may assist the user with predicting his or her shopping list by identifying a smaller set of items in the shopping cart and/or provide a corrective suggestion to the user by analyzing items in the shopping cart (e.g., in the case that the user missed an item or placed a wrong item in the shopping cart). Also, the shopping manager 114 may provide an alternative suggestion to a user about different products that meet the user's needs or tastes. For example, the shopping manager 114 may determine that a similar item is available in the store. The shopping manager 114 may conduct a background analysis of data of similar categories from multiple different sources. The shopping manager 114 may use the sources for predicting a shopping location for missed shopping items in a retail area, such as a shopping mall.

In accordance with embodiments of the present invention, a user profile may define preferences of a user. For example, the preferences may include a list of likes and dislikes for different food items. The shopping manager 114 may use the preferences for filtering or otherwise adjusting the generated shopping list. For example, the shopping manager 114 may determine that peppers are candidate items for list; however, peppers are listed as a dislike for a user. The shopping manager 114 may filter peppers from the list, because peppers are listed as a dislike in the user profile.

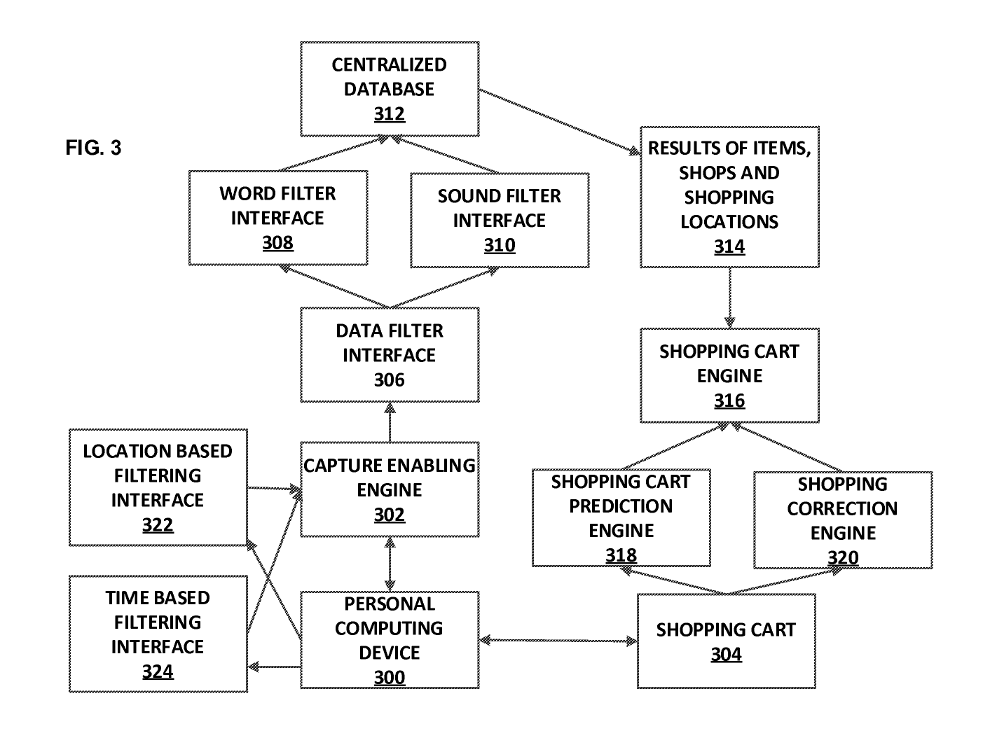

FIG. 3 illustrates a flow diagram of a system for adjusting a shopping planner based on identification of shopping predictors in accordance with embodiments of the present invention. The system includes various components for implementing functionality as described herein. Referring to FIG. 3, the system may include a personal computing device 300 of a user. The personal computing device 300 may be, for example, the computing device 102 shown in FIG. 1. The personal computing device may be configured to interact with a capture enabling engine 302 and a shopping cart 304 as shown in FIG. 3. The capture enabling engine 302 may be a user interface or other engine capable of receiving user interface content. For example, the capture enabling engine 302 may be a touchscreen display, a microphone, a camera, and/or the like of the computing device 300. User interface content may include text, sound, video, images, or other types of data. The shopping cart 304 may be a virtual shopping cart initiated by the user of the personal device for shopping within a store or online. For example, the computing device 300 may be registered and communicatively connected via a network of a retail store for initiating and managing the shopping cart 304. The user may interact with the computing device 304 for selecting one or more items for the shopping cart. Subsequently, the user may interact with the computing device 304 for conducting a purchase transaction for the item(s) contained in the shopping cart 304.

A data filter engine 306 may receive user interface content output from the capture enabling engine 302. The data filter engine 306 may filter the received user interface content. A word filter interface 308 may filter words that are not associated with shopping. A sound filter interface 310 may filter sounds, such as background noise, that are not associated with shopping. The data filter engine 306, the word filter interface 308, and the sound filter interface 310 may be implemented by hardware, software, firmware, or combinations thereof residing on the computing device 300 and/or another computing device. A centralized database 312 stored in the personal computing device 300 or another device may sort words filtered out and generate results of items, shops, and shopping locations 314 in accordance with embodiments of the present invention.

A shopping cart engine 316 may communicate the generated results 314 to a shopping prediction engine 318 and a shopping correction engine 320. The shopping prediction engine 316 may add items to the shopping cart 304 or shopping list based on the results. The shopping correction engine 320 may correct or otherwise edit the shopping cart list. The shopping cart engine 316, the shopping prediction engine 318, and the shopping correction engine 320 may be implemented by hardware, software, firmware, or combinations thereof residing on the computing device 300 and/or another computing device.

A location-based filtering interface 322 and a time-based filtering interface 324 may filter user interface content based on location and time, respectively. For example, a location and time of the user interface content may be filtered by these engines. The location-based filtering interface 322 and the time-based filtering interface 324 may be implemented by hardware, software, firmware, or combinations thereof residing on the computing device 300 and/or another computing device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method comprising:
using at least a processor and memory for:
receiving user interface content;
determining one or more shopping predictors based on the user interface content; and
adjusting a shopping planner based on the one or more identified shopping predictors.

2. The method of claim 1, wherein receiving user interface content comprises receiving one of audio content, video content, multimedia content, and text-based content.

3. The method of claim 1, wherein receiving user interface content comprises receiving audio content via a microphone, and
wherein determining one or more shopping predictors comprises:
transcribing the audio content to text; and
identifying one or more shopping-related words among the text.

4. The method of claim 1, wherein receiving user interface content comprises receiving video content via a multimedia player, and
wherein determining one or more shopping predictors comprises identifying one or more shopping-related words based on the video content.

5. The method of claim 1, wherein receiving user interface content comprises receiving multimedia content via a multimedia player, and
wherein determining one or more shopping predictors comprises identifying one or more shopping-related words based on the multimedia content.

6. The method of claim 1, wherein determining one or more shopping predictors comprises identifying one or more shopping-related words among the text-based content.

7. The method of claim 1, wherein determining one or more shopping predictors comprises determining one or more shopping-related words based on the user interface content.

8. The method of claim 7, further comprising using the at least one processor and memory for:
defining a plurality of categories within the shopping planner; and
associating each of the shopping-related words with one of the categories.

9. The method of claim 1, further comprising using the at least one processor and memory for:
determining one or more items in a shopping cart;
generating a suggestion for shopping based on the shopping planner and the items in the shopping cart; and
presenting the suggestion via a user interface.

10. The method of claim 9, wherein generating a suggestion comprises one of identifying another item for purchase and identifying a shopping location for purchase of another item.

11. The method of claim 1, further comprising presenting the shopping planner via a user interface.

12. A computing device comprising:
a shopping manager comprising:
receive user interface content;
determine one or more shopping predictors based on the user interface content; and
adjust a shopping planner based on the one or more identified shopping predictors; and
a user interface configured to present the shopping planner.

13. The computing device of claim 12, wherein the shopping manager is configured to receive one of audio content, video content, multimedia content, and text-based content.

14. The computing device of claim 12, wherein the shopping manager is configured to:
receive audio content via a microphone;
transcribe the audio content to text; and
identify one or more shopping-related words among the text.

15. The computing device of claim 12, wherein the shopping manager is configured to:
receive user interface content comprises receiving video content via a multimedia player; and
identify one or more shopping-related words based on the video content.

16. The computing device of claim 12, wherein the shopping manager is configured to:
receive multimedia content via a multimedia player; and
identify one or more shopping-related words based on the multimedia content.

17. The computing device of claim 12, wherein the shopping manager is configured to identify one or more shopping-related words among the text-based content.

18. The computing device of claim 12, wherein the shopping manager is configured to determine one or more shopping-related words based on the user interface content.

19. The computing device of claim 18, wherein the shopping manager is configured to:
define a plurality of categories within the shopping planner; and
associate each of the shopping-related words with one of the categories.

20. The computing device of claim 12, wherein the shopping manager is configured to:
determine one or more items in a shopping cart;
generate a suggestion for shopping based on the shopping planner and the items in the shopping cart; and
present the suggestion via a user interface.

21. The computing device of claim 20, wherein the shopping manager is configured to one of identifying another item for purchase and identify a shopping location for purchase of another item.

22. A computer program product comprising a computer readable storage medium having program instructions embodied therewith, the program instructions executable by a computing device to cause the computing device to:
receive, by the computing device, user interface content;
determine, by the computing device, one or more shopping predictors based on the user interface content; and
adjust, by the computing device, a shopping planner based on the one or more identified shopping predictors.
